(19) United States
(12) Patent Application Publication
(10) Pub. No.: US 2008/0295780 A1
(43) Pub. Date: Dec. 4, 2008

(54) Warming Device for Pet

(76) Inventor: Chun-Yi Huang, Shengang Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/755,139

(22) Filed: May 30, 2007

(51) Int. Cl. A01K 1/035; H05B 3/06

(52) U.S. Cl. 119/482; 219/520

(57) ABSTRACT

A warming device includes a main body, a receiving socket mounted on the main body, a heating member mounted in the receiving socket to provide a warming effect to the main body, and a control unit connected to the heating member to control operation of the heating member. Thus, the heating member is mounted on the main body to provide a warming effect to a pet when the temperature is very low, thereby providing a comfortable sensation to the pet. In addition, the pet can be received in the main body which has a doghouse shape or directly put on the main body which has a clothing shape, thereby facilitating a user using the warming device. Further, the control unit is power recharageable so that the warming device is used outdoors easily and conveniently.

### BACKGROUND OF THE INVENTION

1. Field of the Invention

The present invention relates to a warming device and, more particularly, to a warming device for a pet.

2. Description of the Related Art

A pet clothing is available for a pet, such as a dog, cat or the like. Thus, the pet can put on the pet clothing to have an outstanding outer appearance and to keep a warming effect. However, the pet clothing has an expensive price. In addition, the pet clothing cannot keep a warming effect efficiently when the temperature is very low in the winter.

### BRIEF SUMMARY OF THE INVENTION

In accordance with the present invention, there is provided a warming device for a pet, comprising a hollow main body, a receiving socket mounted on the main body, a heating member mounted in the receiving socket to provide a warming effect to the main body, and a control unit connected to the heating member to control operation of the heating member.

The primary objective of the present invention is to provide a warming device for a pet, wherein the heating member is mounted on the main body to provide a warming effect to a pet when the temperature is very low, thereby providing a comfortable sensation to the pet.

Another objective of the present invention is to provide a warming device for a pet, wherein the pet can be received in the main body which has a substantially doghouse shape or directly put on the main body which has a clothing shape, thereby facilitating a user using the warming device.

A further objective of the present invention is to provide a warming device for a pet, wherein the heating member has a resilient feature so that the heating member is bendable to fit the shape of the main body, thereby facilitating the user carrying the warming device.

A further objective of the present invention is to provide a warming device for a pet, wherein the control unit is power recharageable so that the warming device is used outdoors easily and conveniently.

A further objective of the present invention is to provide a warming device for a pet, wherein the warming device is disassembled, so that the main body can be washed and cleaned easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a warming device for a pet in accordance with the preferred embodiment of the present invention.

FIG. 2 is a locally perspective enlarged view of the warming device for a pet as shown in FIG. 1.

FIG. 3 is a partially front cross-sectional view of a warming device for a pet in accordance with another preferred embodiment of the present invention.

FIG. 4 is a perspective view of a warming device for a pet in accordance with another preferred embodiment of the present invention.

### DETAILED DESCRIPTION OF THE INVENTION

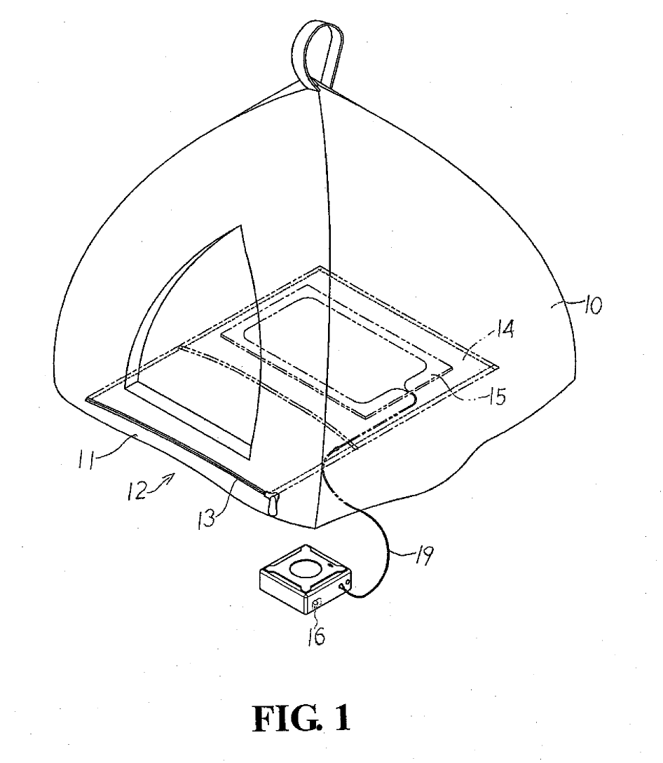

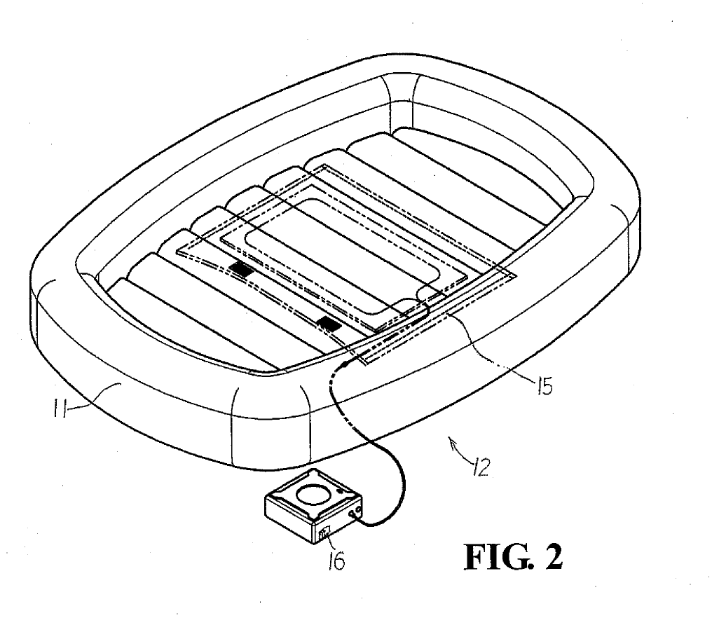

Referring to the drawings and initially to FIGS. 1 and 2, a warming device for a pet in accordance with the preferred embodiment of the present invention comprises a hollow main body 10 having a bottom board 11, a receiving socket 14 mounted on the main body 10 and rested on the bottom board 11 of the main body 10, a heating member 15 mounted in the receiving socket 14 to provide a warming effect to the bottom board 11 of the main body 10, and a control unit 16 connected to the heating member 15 to control operation of the heating member 15.

The main body 10 has a substantially doghouse shape to receive the pet. The bottom board 11 of the main body 10 has a side formed with an entrance 12 connected to the receiving socket 14 to allow entrance of the heating member 15 into the receiving socket 14. The entrance 12 of the bottom board 11 of the main body 10 is provided with a zipper 13 to open or close the entrance 12 of the bottom board 11 of the main body 10.

The heating member 15 is an elongated sheet plate and has a resilient feature. The heating member 15 is rested on the bottom board 11 of the main body 10 to provide a warming effect to the bottom board 11 of the main body 10. The heating member 15 is separated from the main body 10 by the receiving socket 14 to ensure a safety use of the heating member 15.

The control unit 16 is located outside of the main body 10 and the receiving socket 14 and is electrically connected to the heating member 15 by an electric cord 19 to supply an electric power to the heating member 15. Preferably, the control unit 16 is power recharageable.

In practice, when the heating member 15 is operated by the control unit 16, the heating member 15 transmits the heat through the bottom board 11 of the main body 10 into the inside of the main body 10 to provide a warming effect to the pet contained in the inside of the main body 10.

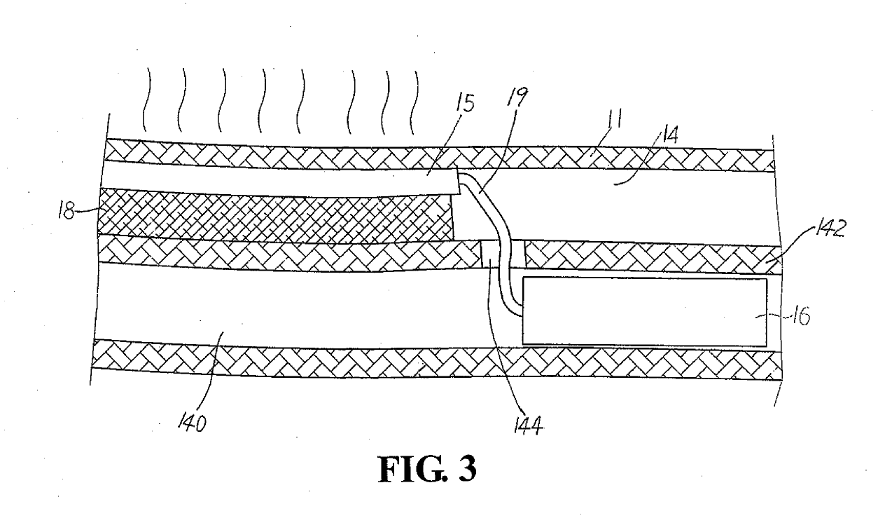

Referring to FIG. 3, the warming device further comprises a heat insulating member 18 mounted in the receiving socket 14 and rested on the heating member 15 which is sandwiched between the bottom board 11 of the main body 10 and the heat insulating member 18, a secondary receiving socket 140 mounted on a bottom of the receiving socket 14 to receive the control unit 16 which is separated from the heating member 15, and a separation wall 142 located between the receiving socket 14 and the secondary receiving socket 140 to separate the control unit 16 from the heating member 15 and formed with a passage 144 connected between the receiving socket 14 and the secondary receiving socket 140 to allow passage of the electric cord 19.

In such a manner, the heating member 15 is sandwiched between the bottom board 11 of the main body 10 and the heat insulating member 18, so that the heat transmitted from the heating member 15 is completely directed toward and concentrated onto the bottom board 11 of the main body 10, thereby enhancing the warming effect to the inside of the main body 10.

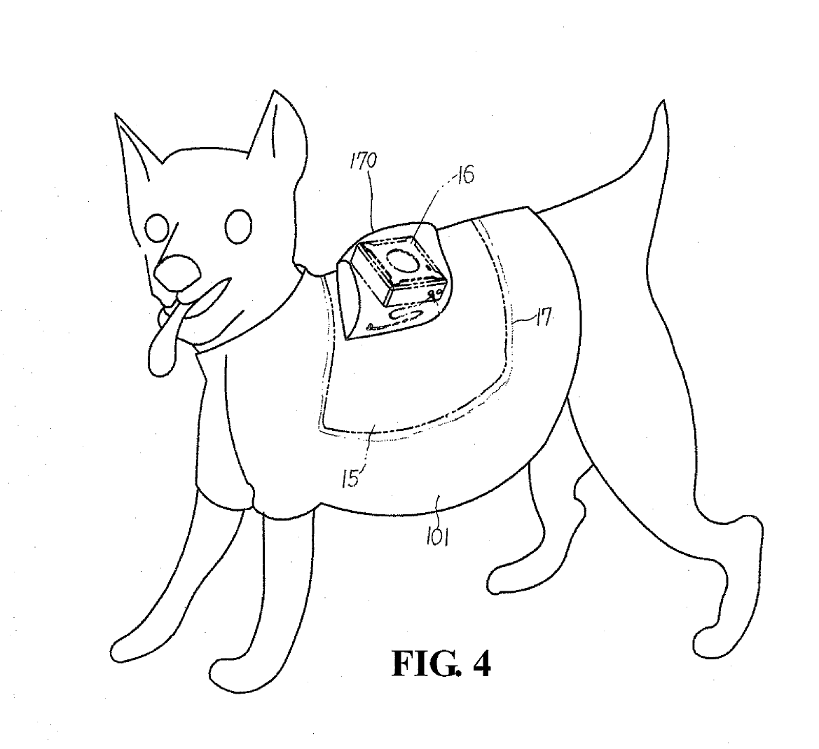

Referring to FIG. 4, the warming device comprises a hollow main body 101, a receiving socket 17 mounted on an inner face of the main body 101, a heating member 15 mounted in the receiving socket 17 to provide a warming effect to the inner face of the main body 10, a control unit 16 connected to the heating member 15 to control operation of the heating member 15, and a secondary receiving socket 170 mounted on an outer face of the main body 101 to receive the control unit 16. The main body 101 has a clothing shape so that the pet can wear the main body 101. The heating member 15 is separated from the main body 101 by the receiving socket 17 to ensure a safety use of the heating member 15.

In practice, when the pet can wear the main body 101, the receiving socket 17 is rested on the pet's body. Thus, when the heating member 15 in the receiving socket 17 is operated by the control unit 16, the heating member 15 transmits the heat through the receiving socket 17 onto the pet's body to provide a warming effect to the pet wearing the main body 101.

Accordingly, the heating member 15 is mounted on the main body 10 or 101 to provide a warming effect to a pet when the temperature is very low, thereby providing a comfortable sensation to the pet. In addition, the pet can be received in the main body 10 which has a substantially doghouse shape or directly put on the main body 101 which has a clothing shape, thereby facilitating a user using the warming device. Further, the heating member 15 has a resilient feature so that the heating member 15 is bendable to fit the shape of the main body 10 or 101, thereby facilitating the user carrying the warming device. Further, the control unit 16 is power recharageable so that the warming device is used outdoors easily and conveniently. Further, the warming device is disassembled, so that the main body 10 or 101 can be washed and cleaned easily and quickly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A warming device for a pet, comprising:
a hollow main body;
a receiving socket mounted on the main body;
a heating member mounted in the receiving socket to provide a warming effect to the main body;
a control unit connected to the heating member to control operation of the heating member.

2. The warming device in accordance with claim 1, wherein:
the main body has a bottom board;
the receiving socket is rested on the bottom board of the main body.

3. The warming device in accordance with claim 2, wherein the main body has a substantially doghouse shape.

4. The warming device in accordance with claim 2, wherein the bottom board of the main body has a side formed with an entrance connected to the receiving socket to allow entrance of the heating member into the receiving socket.

5. The warming device in accordance with claim 4, wherein the entrance of the bottom board of the main body is provided with a zipper to open or close the entrance of the bottom board of the main body.

6. The warming device in accordance with claim 2, wherein the heating member is an elongated sheet plate.

7. The warming device in accordance with claim 2, wherein the heating member has a resilient feature.

8. The warming device in accordance with claim 2, wherein the heating member is rested on the bottom board of the main body.

9. The warming device in accordance with claim 2, wherein the heating member is separated from the main body by the receiving socket.

10. The warming device in accordance with claim 1, wherein the control unit is located outside of the main body and the receiving socket.

11. The warming device in accordance with claim 2, further comprising a heat insulating member mounted in the receiving socket and rested on the heating member, wherein the heating member is sandwiched between the bottom board of the main body and the heat insulating member.

12. The warming device in accordance with claim 2, further comprising a secondary receiving socket mounted on a bottom of the receiving socket to receive the control unit, wherein the control unit is separated from the heating member.

13. The warming device in accordance with claim 12, further comprising a separation wall located between the receiving socket and the secondary receiving socket to separate the control unit from the heating member.

14. The warming device in accordance with claim 13, wherein the control unit is electrically connected to the heating member by an electric cord, and the separation wall is formed with a passage connected between the receiving socket and the secondary receiving socket to allow passage of the electric cord.

15. The warming device in accordance with claim 1, wherein:
the receiving socket is mounted on an inner face of the main body;
the heating member provides a warming effect to the inner face of the main body.

16. The warming device in accordance with claim 15, further comprising a secondary receiving socket mounted on an outer face of the main body to receive the control unit.

17. The warming device in accordance with claim 15, wherein the main body has a clothing shape.

18. The warming device in accordance with claim 15, wherein the heating member is separated from the main body by the receiving socket.

19. The warming device in accordance with claim 15, wherein the heating member is an elongated sheet plate.

20. The warming device in accordance with claim 15, wherein the heating member has a resilient feature.
